(19) United States
(12) Patent Application Publication
(10) Pub. No.: US 2024/0010139 A1
(43) Pub. Date: Jan. 11, 2024

(54) Fastener Assembly for Vehicle

(71) Applicants: Hyundai Motor Company, Seoul (KR); Kia Corporation, Seoul (KR)

(72) Inventors: Dong-Han Kim, Yongin-si (KR); Joo-Hee Lee, Cheongju-si (KR)

(21) Appl. No.: 18/337,364

(22) Filed: Jun. 19, 2023

(30) Foreign Application Priority Data
Jul. 8, 2022 (KR) 10-2022-0084426

(51) Int. Cl. B60R 13/02; F16B 19/06

(52) U.S. Cl. CPC B60R 13/0206; F16B 19/06

(57) ABSTRACT

An embodiment fastener assembly for a vehicle includes a first member coupled to a vehicle trim and including a first coupling protrusion on a surface of the first member directed toward a panel and a second member coupled to the panel and including a second coupling protrusion on a surface of the second member directed toward the vehicle trim, the second coupling protrusion being coupled to the first coupling protrusion, wherein the first member and the second member are coupled to each other by coupling of the first coupling protrusion to the second coupling protrusion.

### CROSS-REFERENCE TO RELATED APPLICATIONS

This application claims the benefit of Korean Patent Application No. 10-2022-0084426, filed on Jul. 8, 2022, which application is hereby incorporated herein by reference.

### TECHNICAL FIELD

The present disclosure relates to a fastener assembly for a vehicle.

### BACKGROUND

An interior of a vehicle is finished by coupling trims to panels that define a vehicle body. For example, as illustrated in FIG. 1, a trim 142 is coupled to a panel 141 of a door.

As illustrated in FIG. 2, a fastener 100 is applied to couple the trim 142 to the panel 141 even without using a tool. In a state in which the fastener 100 is coupled to the trim 142, the trim 142 is positioned at an assembling position and pushed, such that the trim 142 is coupled to the panel 141.

The fastener 100 includes a mounting portion 11 mounted on the trim 142, a connection portion 112 protruding from the mounting portion 11, a head portion 113 provided at an end of the connection portion 112 and having a cross-section that decreases toward an end thereof so that the fastener 100 is easily inserted into the panel 141, and an elastic portion 114 spaced apart from the connection portion 112, extending from the head portion 113 toward the mounting portion 111, and coupled to the panel 141.

The fastener 100 in the related art has a long length h, which causes interference between the fastener 100 and another component mounted between the panel 141 and the trim 142.

For example, as illustrated in FIG. 3, a door latch 145 is mounted in the door of the vehicle. Because the portion where the door latch 145 is mounted does not have a sufficient space in the panel 141, the fastener 100 interferes with the door latch 145 (see E of FIG. 4). As described above, because the fastener 100 is not completely inserted into the panel 141 because of the component mounted in the panel 141, the trim 142 is separated from the panel 141.

When the trim 142 is separated from the panel 141 as described above, an aesthetic appearance deteriorates, and foreign substances such as moisture or dust are introduced between the trim 142 and the panel 141 through a gap formed by the separation of the trim 142.

The foreign substances introduced between the trim 142 and the panel 141 causes malfunction of a device mounted on the panel. For example, the door latch 145, a window regulator, a speaker, and the like are mounted in the panel 141 of the door, and the foreign substances cause the malfunction of the devices.

### SUMMARY

The present disclosure relates to a fastener assembly for a vehicle. Particular embodiments relate to a fastener assembly for a vehicle that is used to mount a vehicle trim on a panel. Further embodiments relate to a fastener assembly for a vehicle that has a small height so as not to interfere with another assembly on which a panel is mounted.

Accordingly, an embodiment of the present disclosure provides a fastener assembly for a vehicle that has a small length so as not to interfere with another constituent element installed on a vehicle trim or panel.

As a preferred embodiment, a fastener assembly for a vehicle includes a first member coupled to a vehicle trim and having a first coupling protrusion formed on a surface of the first member directed toward a panel and a second member coupled to the panel and having a second coupling protrusion formed on a surface of the second member directed toward the trim, the second coupling protrusion being coupled to the first coupling protrusion, in which the first member and the second member are coupled to each other by coupling the first coupling protrusion to the second coupling protrusion.

The first coupling protrusion may include a stem protruding from the first member and a head disposed at an end of the stem and having a larger width than the stem, and the second coupling protrusion may include a stem protruding from the second member and a head disposed at an end of the stem and having a larger width than the stem.

The first coupling protrusion may be provided as a plurality of first coupling protrusions, the plurality of first coupling protrusions may be formed on the first member at predetermined intervals, the second coupling protrusion may be provided as a plurality of second coupling protrusions, and the plurality of second coupling protrusions may be formed on the second member at intervals equal to the intervals at which the first coupling protrusions are arranged.

A gap between the heads of the adjacent two first coupling protrusions may be smaller than a width of the head of each of the second coupling protrusions.

The first member may have a plurality of fastening holes penetrated by ribs that are protruded from the trim.

The ribs may be coupled to the first member by ultrasonic welding.

The second member may have a fastening part formed on a rear surface of the second member opposite to the surface of the second member on which the second coupling protrusion is formed, and the fastening part may couple the second member to an assembling hole formed in the panel.

The fastening part may include a base having one end connected to the second member and a fixing portion disposed at an outer portion of the base and directed toward the outside of the second member. The base may be provided as a pair of bases disposed to be horizontally symmetric, the fixing portion may be provided as a pair of fixing portions disposed to be horizontally symmetric, and the fastening part may be elastically deformed, restored after passing through the assembling hole, and caught by a periphery of the assembling hole, such that the second member is fixed to the panel.

The fastening part may be elastically deformed in a plane parallel to the panel.

The fastening part may be elastically deformed to pass through the assembling hole or restored after passing through the assembling hole as the base rotates parallel to the panel around a portion connected to the second member.

The pair of the base and the fixing portion may pass through the assembling hole by rotating parallel to the panel in the direction of gathering together and may be restored by rotating parallel to the panel after passing through the assembling hole.

The fastening part may be downwardly inclined toward the second member toward two opposite ends of the second member.

The fastener assembly may further include a first stopper and a second stopper formed on the second member, spaced apart from each other, and configured to restrict a movement of the second member after the fastening part is coupled to the assembling hole.

The first stopper may protrude from the second member and be connected to an upper end of the fastening part, and a width of the first stopper may be formed as a width of the assembling hole.

The second stopper may protrude from the second member at a position spaced apart from the first stopper at an interval.

A catching portion may be formed on the second stopper and extend from an upper end of the second stopper toward the first stopper, and a planar portion parallel to the second member may be formed on the fixing portion and provided at a portion positioned below the catching portion.

The fastener assembly may further include a sealing member fitted with a periphery of any one of the first member and the second member and configured to seal a portion between the first member and the trim or a portion between the second member and the panel.

The sealing member may include a through-hole with which the periphery of the first member or second member is fitted and a sealing portion configured to adjoin the trim or the panel and extending from a portion where the through-hole is formed.

The sealing member may be fitted with the periphery of the second member and seal the portion between the second member and the panel.

According to the fastener assembly for a vehicle according to embodiments of the present disclosure configured as described above, the length of the fastener assembly may decrease. Therefore, it is possible to prevent interference between the fastener assembly and another component installed on the trim or panel while maintaining the same working convenience during the process of coupling the trim to the panel.

In addition, because no interference occurs, the assembled portions between the trim and the panel are not separated. Therefore, it is possible to prevent foreign substances from being introduced through a gap caused by the separation of the assembled portions between the trim and the panel.

### BRIEF DESCRIPTION OF THE DRAWINGS

FIG. 1 is a schematic view illustrating a state in which an interior of a door of a typical vehicle is finished.

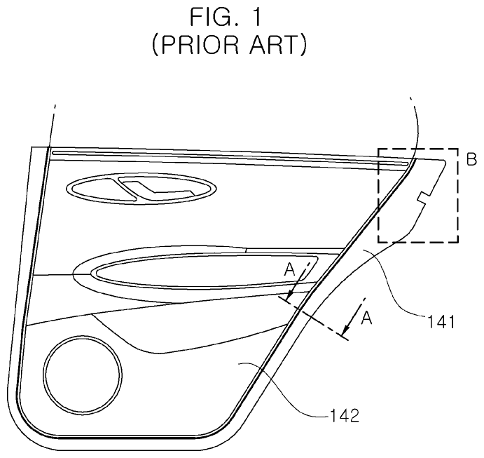

FIG. 2 is a cross-sectional view taken along line A-A in FIG. 1.

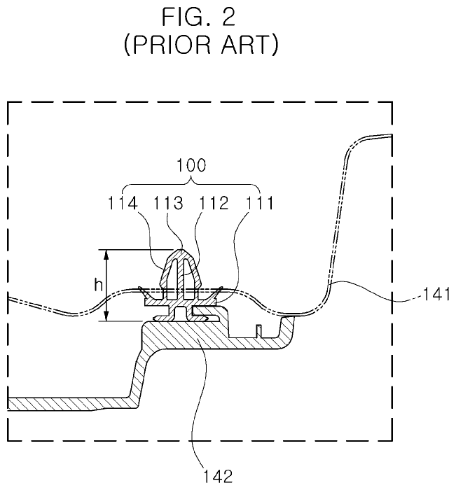

FIG. 3 is an enlarged view of part B in FIG. 1.

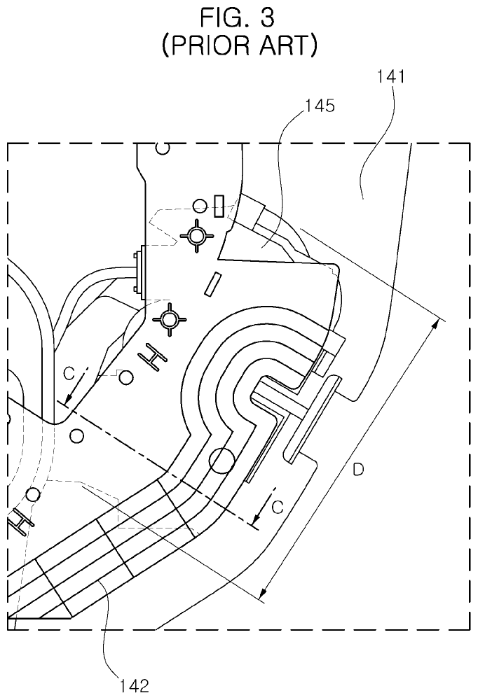

FIG. 4 is a cross-sectional view taken along line C-C in FIG. 3.

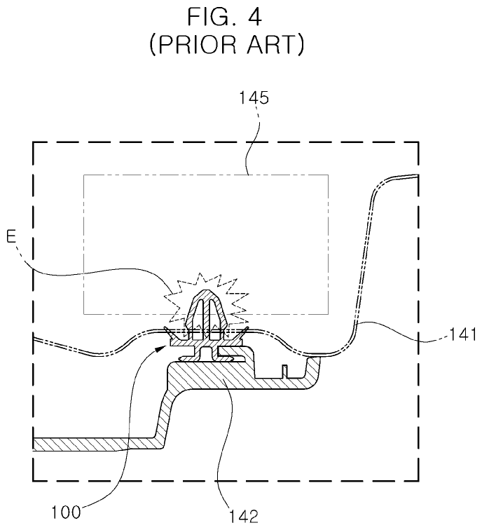

FIG. 5 is a perspective view illustrating a fastener assembly for a vehicle according to embodiments of the present disclosure.

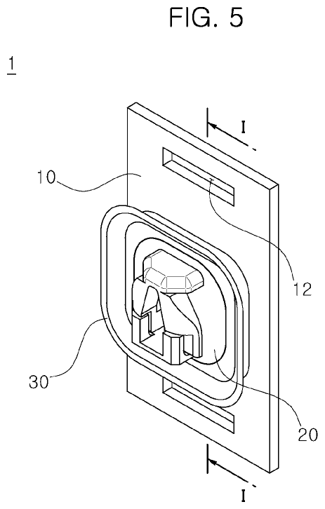

FIG. 6 is an exploded perspective view illustrating the fastener assembly for a vehicle according to embodiments of the present disclosure.

FIG. 7 is a top plan view illustrating a second member of the fastener assembly for a vehicle according to embodiments of the present disclosure.

FIG. 8 is a cross-sectional view of the fastener assembly for a vehicle according to embodiments of the present disclosure.

FIG. 9 is a perspective view illustrating coupling protrusions of a first member and coupling protrusions of a second member according to another embodiment of the present disclosure.

FIG. 10 is a perspective view illustrating a state in which the fastener assembly for a vehicle according to embodiments of the present disclosure is temporarily assembled.

FIG. 11 is a perspective view illustrating a state in which the fastener assembly for a vehicle according to embodiments of the present disclosure is coupled to a trim.

FIG. 12 is a perspective view illustrating a state in which the fastener assembly for a vehicle according to embodiments of the present disclosure is coupled to the trim.

FIG. 13 is a perspective view illustrating a state in which the trim coupled to the fastener assembly for a vehicle according to embodiments of the present disclosure is coupled to a panel.

FIG. 14 is a perspective view illustrating a state in which the trim coupled to the fastener assembly for a vehicle according to embodiments of the present disclosure is coupled to the panel.

FIG. 15 is a perspective view illustrating a state in which the trim is separated from the panel in an assembly structure in which the fastener assembly for a vehicle according to embodiments of the present disclosure is fastened.

### DETAILED DESCRIPTION OF ILLUSTRATIVE EMBODIMENTS

Hereinafter, embodiments of the present disclosure will be described in detail with reference to the exemplary accompanying drawings, and since these embodiments, as examples, may be implemented in various different forms by those skilled in the art to which the present disclosure pertains, they are not limited to the embodiments described herein.

Hereinafter, a fastener assembly for a vehicle according to embodiments of the present disclosure will be described in detail with reference to the accompanying drawings.

A fastener assembly for a vehicle according to embodiments of the present disclosure includes a first member 10 coupled to a vehicle trim 42 and having first coupling protrusions 11 formed on a surface of the first member 10 directed toward a panel 41 and a second member 20 coupled to the panel 41 and having second coupling protrusions 21 formed on a surface of the second member 20 directed toward the trim 42, the second coupling protrusions 21 being coupled to the first coupling protrusions 11. The first member 10 and the second member 20 are coupled to each other by coupling the first coupling protrusions 11 to the second coupling protrusions 21.

The first member 10 is coupled to the trim 42 between the vehicle trim 42 and the panel 41.

The first coupling protrusions 11 are formed on the surface of the first member 10 directed toward the panel 41, and the first coupling protrusions 11 are coupled to the second member 20. The first coupling protrusions 11 protrude from the first member 10 and are coupled to the second coupling protrusions 21 formed on the second member 20, such that the first member 10 and the second member 20 are coupled to each other.

Referring to a cross-sectional shape of the first coupling protrusion 11, the first coupling protrusion 11 has a stem 11a protruding from the first member 10, and a head 11b disposed at an end of the stem 11a and having a width larger than a width of the stem 11a. An end of the head 11b has a rounded shape so that the head 11b is easily coupled and provides a secure fastening force.

The first coupling protrusion 11 is provided as a plurality of first coupling protrusions 11, and the plurality of first coupling protrusions 11 is disposed on the first member 10 at predetermined intervals.

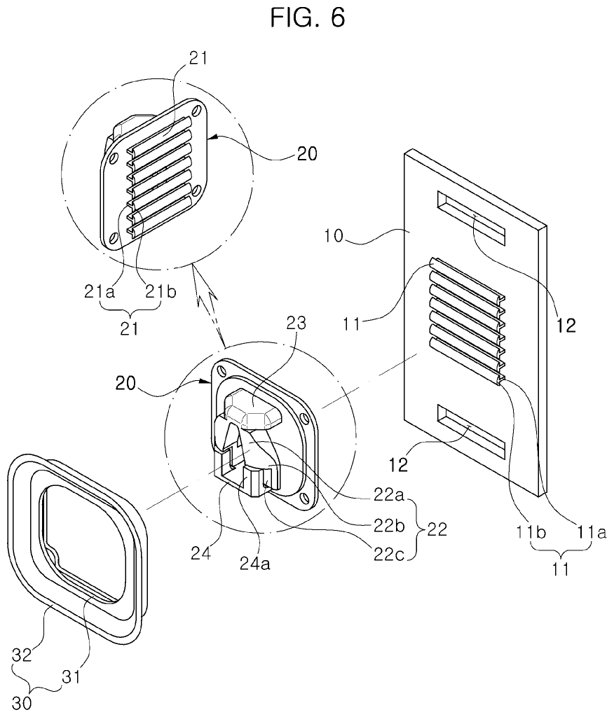

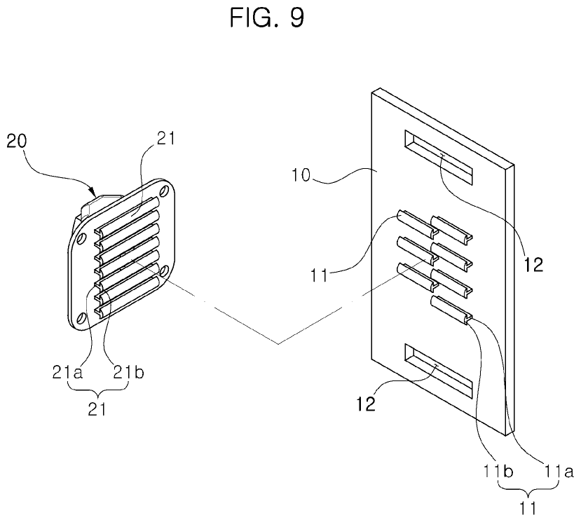

In addition, the first coupling protrusions 11 may have the same width (a width in a leftward/rightward direction in FIG. 6). However, in some instances, the first coupling protrusions 11 may have different widths. For example, as illustrated in FIG. 6, the first coupling protrusions 11 may be formed over the entire length thereof. However, as illustrated in FIG. 9, the first coupling protrusions 11 may be alternately formed at left and right sides from above to below.

To fix the first member 10 to the trim 42, fastening holes 12 are formed at one side of the trim 42. Ribs 42a protrude from the trim 42, the fastening holes 12 are formed at one side of the first member 10, and the ribs 42a penetrate the fastening holes 12. In a state in which the first member 10 is disposed on the trim 42 so that the ribs 42a penetrate the fastening holes 12, the ribs 42a and the first member 10 are integrated by welding, particularly, ultrasonic welding. Therefore, the first member 10 is coupled to the trim 42. The fastening hole 12 is provided as a plurality of fastening holes 12, and the plurality of fastening holes 12 is formed at intervals in the first member 10, and the first member 10 is fastened to the trim 42 at a plurality of points. Therefore, the first member 10 may be securely fastened to the trim 42.

The second member 20 is coupled to the panel 41, and the second coupling protrusions 21 are formed on the surface of the second member 20 directed toward the trim 42.

Like the first coupling protrusion 11, the second coupling protrusion 21 formed on the second member 20 has a cross-section having a stem 21a protruding from the second member 20 and a head 21b disposed at an end of the stem 21a and having a width larger than a width of the stem 21a. The first member 10 and the second member 20 are coupled to each other in a state in which the first coupling protrusions 11 and the second coupling protrusions 21 face each other, such that the first member 10 and the second member 20 are coupled to each other.

The second coupling protrusion 21 is also provided as a plurality of second coupling protrusions 21, and the plurality of second coupling protrusions 21 is formed on the second member 20 at predetermined intervals. In this case, the interval between the arranged second coupling protrusions 21 may be equal to the interval between the arranged first coupling protrusions 11.

In addition, like the first coupling protrusions 11, the second coupling protrusions 21 may have the same width, or the second coupling protrusions 21 may be alternately formed at left and right sides from above to below. However, particularly, any one of the first coupling protrusions 11 and the second coupling protrusions 21 may have a width equal to an overall length thereof.

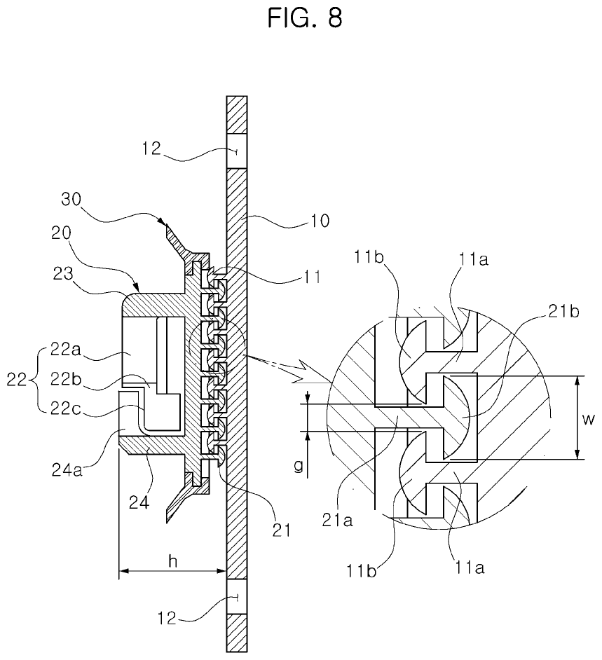

Further, as illustrated in FIG. 8, a gap g between the heads 11b of the adjacent two first coupling protrusions 11 may be smaller than a width w of the head 21b of each of the second coupling protrusions 21 so that the first coupling protrusions 11 and the second coupling protrusions 21 may be coupled to one another and provide a coupling force. Alternatively, a gap between the heads 21b of the adjacent two second coupling protrusions 21 may be smaller than a width of the head 11b of each of the first coupling protrusions 11.

A fastening part 22 configured to fasten the second member 20 to the panel 41 is formed on a rear surface of the second member 20 opposite to the surface of the second member 20 on which the second coupling protrusions 21 are formed.

The fastening part 22 includes bases 22a each having one end connected to the second member 20 and fixing portions 22b formed at outer portions of the bases 22a and directed toward the outside of the second member 20.

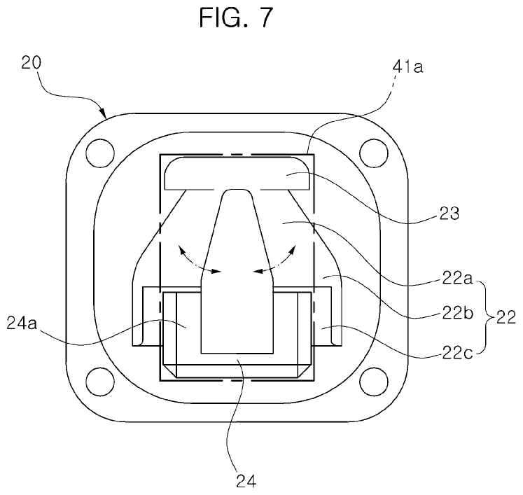

One end (an upper end in FIG. 7) of the base 22a is connected to the second member 20. Because one end of the base 22a is connected to the second member 20, the fastening part 22 is elastically deformed and then restored. That is, when the fastening part 22 fastens the second member 20 to the panel 41, the remaining portion of the base 22a is elastically deformed with respect to one end of the base 22a and passes through an assembling hole 41a of the panel 41 and then is restored to an original shape thereof. The remaining portion of the base 22a, except for a portion connected to the second member 20, is spaced apart from the second member 20 with a predetermined gap, and the panel 41 is positioned in the gap.

The fixing portion 22b extends from the base 22a. The fixing portion 22b extends in a longitudinal direction of the second member 20 and a width direction of the second member 20. Therefore, the fixing portion 22b is fixed to the assembling hole 41a which is formed in the panel 41 and to which the fastening part 22 is assembled.

The base 22a is provided as a pair of bases 22a disposed to be horizontally symmetric, and the fixing portion 22b is provided as a pair of fixing portions 22b disposed to be horizontally symmetric. In addition, the base 22a and the fixing portion 22b are directed toward two opposite ends (left and right ends in FIG. 7) of the second member 20 toward the end of the fixing portion 22b from the portion where the base 22a is connected to the second member 20. The pair of bases 22a and the pair of fixing portions 22b are formed to be spread toward lateral ends thereof. A width of the fastening part 22 is larger than a width of the assembling hole 41a so that the fastening part 22 is kept fitted into the assembling hole 41a. Therefore, the fixing portion 22b is caught by a periphery of the assembling hole 41a after the fastening part 22 is assembled to the assembling hole 41a, such that the second member 20 is fixed to the panel 41.

The base 22a and the fixing portion 22b are downwardly inclined toward two opposite ends of the second member 20 so that the fastening part 22 may be easily assembled to the assembling hole 41a. In addition, to prevent the fastening part 22 from separating from the panel 41 after the fastening part 22 is fitted into the assembling hole 41a, a bottom surface of the base 22a and a bottom surface of the fixing portion 22b are each formed as a flat surface parallel to the panel 41.

A planar portion 22c parallel to the second member 20 is formed in a partial region of the fixing portion 22b. The planar portion 22c is formed below a catching portion 24a to be described below.

The base 22a and the fixing portion 22b are fastened to the assembling hole 41a while being deformed into planes parallel to the panel 41. The base 22a and the fixing portion 22b are elastically deformed on a plane parallel to the panel 41 as the base 22a is folded or opened around a portion where the base 22a is connected to the second member 20. In other words, the fastening part 22 is elastically deformed to pass through the assembling hole 41a or restored after passing through the assembling hole 41a, as the base 22a rotates in parallel with the panel 41 around a portion connected to the second member 20. That is, the pair of bases 22a and the fixing portion 22b are rotated parallel to the panel 41 in a direction of gathering together to pass through the assembling hole 41a and are restored by rotating in parallel with the second member 20 after passing through the assembling hole 41a. Accordingly, the fastening part 22 can be inserted into the assembling hole 41a of the panel 41 and fastened. In order to fasten the second member 20 to the panel 41, a sufficient space in which the second member 20 can be elastically deformed is required. When the second member 20 is elastically deformed in a direction in which the second member 20 is fastened to the panel 41, a space for fastening and deformation of the second member 20 is required. It causes the height of the second member 20 to increase. However, when the second member 20 is deformed on a plane parallel to the panel 41, which is a direction perpendicular to the direction in which the panel 41 is fastened, a space for deformation of the second member 20 is not needed. Accordingly, the height h of the second member 20 may be lowered.

Because the fastener assembly 1 is assembled by coupling the first coupling protrusions 11 and the second coupling protrusions 21 and is fastened to the panel 41 through the fastening part 22, a height h of the fastener assembly 1 may decrease, such that the fastener assembly 1 does not interfere with another component mounted in the panel 41 or mounted on the trim 42.

A first stopper 23 and a second stopper 24 are formed at an interval to prevent the second member 20 from moving after the fastening part 22 of the second member 20 is fixed to the panel 41.

The first stopper 23 and the second stopper 24 reduce a clearance between the fastening part 22 and a periphery of the assembling hole 41a after the fastening part 22 penetrates the assembling hole 41a formed in the panel 41, thereby preventing the fastening part 22 from moving in the assembling hole 41a.

The first stopper 23 protrudes from the second member 20 and is connected to an upper end (based on FIG. 7) of the fastening part 22. Therefore, the fastening part 22 extends from the first stopper 23. In addition, a width of the first stopper 23 is a width of the assembling hole 41a. The first stopper 23 is positioned at one side of the assembling hole 41a, and the width of the first stopper 23 is the width of the assembling hole 41a. Therefore, the movement of the second member 20 toward the first stopper 23 is restricted.

The second stopper 24 protrudes from the second member 20 at a portion spaced apart from the first stopper 23. A width of the second stopper 24 is also the width of the assembling hole 41a, and the second stopper 24 is positioned at the other side of the assembling hole 41a. Therefore, the first stopper 23 and the second stopper 24 may prevent the movement of the second member 20.

The catching portion 24a is formed at an upper end of the second stopper 24 and directed toward the first stopper 23. Because the planar portion 22c is positioned below the catching portion 24a, the planar portion 22c is caught by the catching portion 24a when the second member 20 is about to separate from the assembling hole 41a, such that the catching portion 24a prevents the fastening part 22 from separating from the assembling hole 41a.

The second member 20 is fastened to the assembling hole 41a by the fastening part 22, and the second stopper 24 restricts the separation of the fixing portion 22b, which increases a fastening force of the trim 42.

The first stopper 23 and the second stopper 24 are formed in a region of the second member 20 that is positioned in the assembling hole 41a formed in the panel 41.

The first member 10 and the second member 20 may be manufactured by injection molding.

A sealing member 30 is fitted with a periphery of any one of the first member 10 and the second member 20 and seals a portion between the first member 10 and the trim 42 or seals a portion between the second member 20 and the panel 41. Particularly, the sealing member 30 is fitted with the periphery of the second member 20 and seals the portion between the second member 20 and the panel 41, thereby preventing moisture or foreign substances from being introduced into the panel 41 that defines the vehicle body.

The sealing member 30 includes a through-hole 31 with which the periphery of the first member 10 or the periphery of the second member 20 is fitted and a sealing portion 32 configured to adjoin the trim 42 or the panel 41 and extending from the portion where the through-hole 31 is formed. When the sealing member 30 is fitted with the second member 20, the periphery of the second member 20 is fitted with the through-hole 31, and the sealing portion 32 adjoins the panel 41, such that the portion between the second member 20 and the panel 41 is sealed.

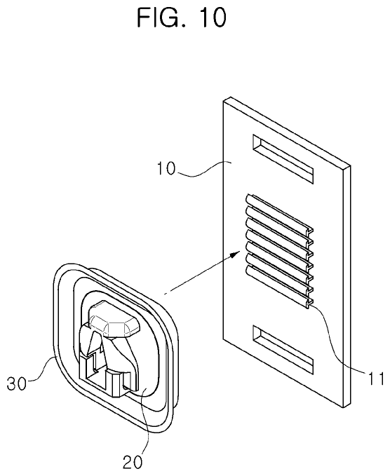

FIGS. 10 to 15 illustrate a process of attaching or detaching the vehicle trim 42 and the panel 41 by using the fastener assembly 1 for a vehicle according to embodiments of the present disclosure configured as described above.

First, as illustrated in FIG. 10, the first member 10 and the second member 20 are fastened to each other to define the fastener assembly 1. The first member 10 and the second member 20, which are separately manufactured, are assembled into the fastener assembly 1 by coupling the first coupling protrusions 11 and the second coupling protrusions 21 to one another in the state in which the first member 10 and the second member 20 are disposed so that the first coupling protrusions 11 and the second coupling protrusions 21 face one another.

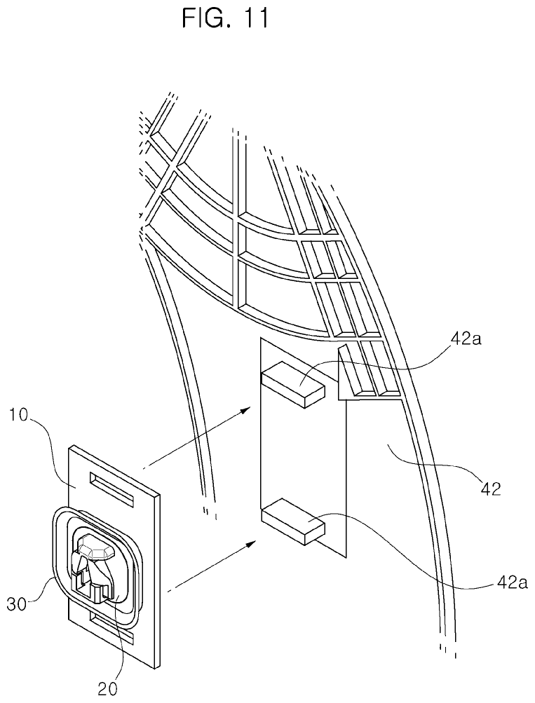

The fastener assembly 1 is assembled to the trim 42 (see FIG. 11). The fastening holes 12 of the first member 10 are fitted with the ribs 42a formed on the trim 42, such that the fastener assembly 1 is primarily assembled to the trim 42.

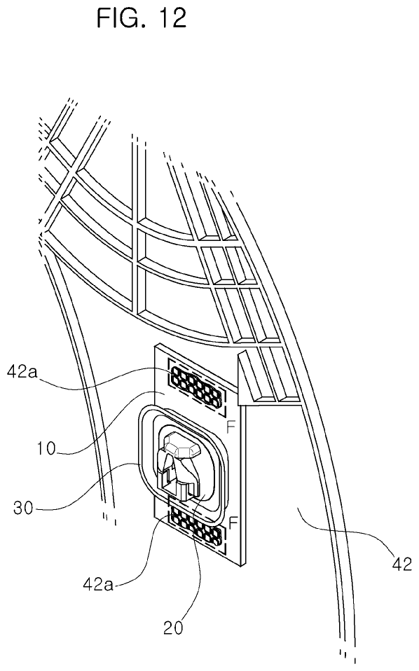

To completely fix the fastener assembly 1 to the trim 42, the ribs 42a and the first member 10 are integrated by welding, particularly, ultrasonic welding. Referring to part F in FIG. 12, the ribs 42a are integrated with the first member 10 by ultrasonic wielding, such that the trim 42 and the fastener assembly 1 constitute a single assembly.

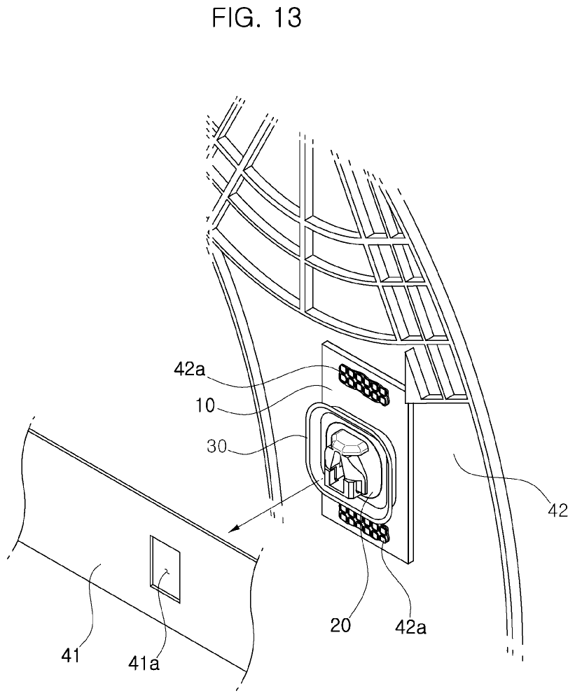

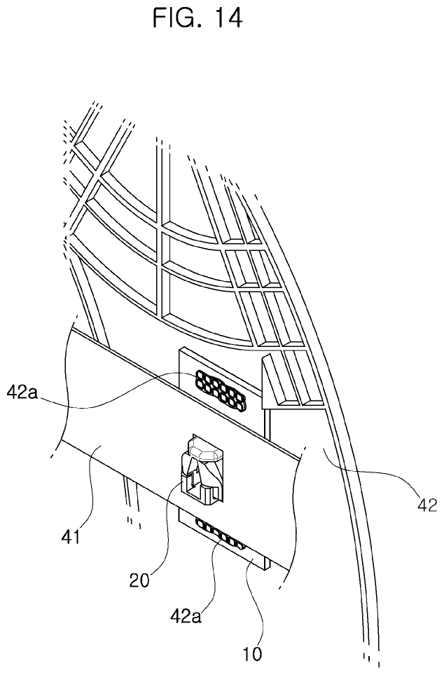

Thereafter, the assembly of the trim 42 and the fastener assembly 1 is assembled to the panel 41. The assembly is positioned so that the second member 20 of the fastener assembly 1 is positioned in the assembling hole 41a formed in the panel 41, and the fastening part 22 of the second member 20 penetrates the assembling hole 41a (see FIG. 13). When the fastening part 22 penetrates the assembling hole 41a, the fastening part 22 is fixed to the assembling hole 41a of the panel 41, such that the trim 42 and the panel 41 are completely assembled (see FIG. 14).

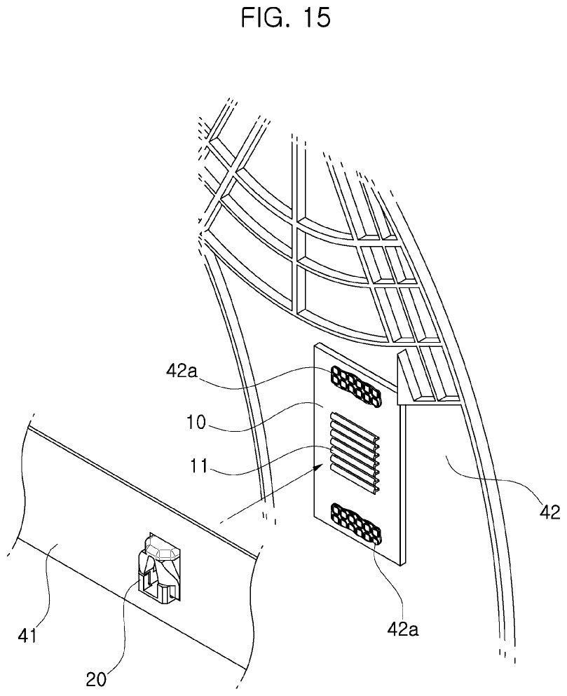

Meanwhile, in a case in which the trim 42 needs to be detached from the panel 41 for maintenance, the trim 42 is pulled in a direction away from the panel 41, such that the trim 42 is separated from the panel 41 (see FIG. 15). In the fastener assembly 1, the first member 10 and the second member 20 are not permanently coupled, but the first member 10 and the second member 20 are coupled as the first coupling protrusions 11 and the second coupling protrusions 21 engage with one another. In addition, because the bottom surface of the fixing portion 22b of the second member 20 is formed as a surface parallel to the panel 41, the second member 20 is continuously kept assembled to the assembling hole 41a. Therefore, when an external force is applied in a direction in which the first member 10 and the second member 20 move away from each other, the first member 10 and the second member 20 are separated from each other as the first coupling protrusions 11 and the second coupling protrusions 21 are separated from one another. Therefore, when the trim 42 is pulled with a sufficient force, the first member 10 and the second member 20 are separated, and the trim 42 is separated from the panel 41.

Thereafter, a new first member 10 is assembled to a new trim 42, and then the first member 10 and the second member 20 are assembled again, such that the new trim 42 may be assembled to the panel 41 again.

What is claimed is:

1. A fastener assembly for a vehicle, the fastener assembly comprising:
a first member coupled to a vehicle trim and comprising a first coupling protrusion on a surface of the first member directed toward a panel; and
a second member coupled to the panel and comprising a second coupling protrusion on a surface of the second member directed toward the vehicle trim, the second coupling protrusion being coupled to the first coupling protrusion, wherein the first member and the second member are coupled to each other by coupling of the first coupling protrusion and the second coupling protrusion.

2. The fastener assembly of claim 1, where:
the first coupling protrusion comprises:
a first stem protruding from the first member; and
a first head disposed at an end of the first stem and having a larger width than the first stem; and
the second coupling protrusion comprises:
a second stem protruding from the second member; and
a second head disposed at an end of the second stem and having a larger width than the second stem.

3. The fastener assembly of claim 2, wherein:
the first coupling protrusion comprises a plurality of first coupling protrusions arranged on the first member at predetermined intervals; and
the second coupling protrusion comprises a plurality of second coupling protrusions arranged on the second member at intervals equal to the intervals at which the first coupling protrusions are arranged.

4. The fastener assembly of claim 3, wherein a gap between the heads of adjacent first coupling protrusions is smaller than a width of the head of each of the second coupling protrusions.

5. The fastener assembly of claim 1, wherein the first member comprises a plurality of fastening holes, and wherein the fastening holes are penetrated by ribs protruding from the vehicle trim.

6. The fastener assembly of claim 5, wherein the ribs are coupled to the first member by ultrasonic welding.

7. A fastener assembly for a vehicle, the fastener assembly comprising:
a first member coupled to a vehicle trim and comprising a first coupling protrusion on a surface of the first member directed toward a panel; and
a second member coupled to the panel, the second member comprising:
a second coupling protrusion on a first surface of the second member directed toward the vehicle trim, the second coupling protrusion being coupled to the first coupling protrusion, wherein the first member and the second member are coupled to each other by coupling of the first coupling protrusion to the second coupling protrusion; and
a fastening part on a second surface of the second member opposite the first surface of the second member, wherein the second member is coupled to an assembling hole in the panel by the fastening part.

8. The fastener assembly of claim 7, wherein the fastening part comprises:
a base having a first end connected to the second member; and
a fixing portion disposed at an outer portion of the base and directed toward an exterior of the second member.

9. The fastener assembly of claim 7, wherein:
the fastening part comprises:
a pair of bases disposed to be horizontally symmetric, each of the bases having a first end connected to the second member;
a pair of fixing portions disposed to be horizontally symmetric at outer portions of the pair of bases, respectively, wherein the fixing portions are directed toward an exterior of the second member; and
the fastening part is configured to be elastically deformed while passing through the assembling hole, restored after passing through the assembling hole, and caught by a periphery of the assembling hole, such that the second member is fixed to the panel.

10. The fastener assembly of claim 9, wherein the fastening part is elastically deformed in a plane parallel to the panel.

11. The fastener assembly of claim 10, wherein the fastening part is elastically deformed to pass through the assembling hole or restored after passing through the assembling hole by the base rotating parallel to the panel around a portion connected to the second member.

12. The fastener assembly of claim 11, wherein the pair of the bases and the pair of the fixing portions are configured to pass through the assembling hole by rotating parallel to the panel in a direction of gathering together and are configured to be restored by rotating parallel to the panel after passing through the assembling hole.

13. The fastener assembly of claim 9, wherein the fastening part is downwardly inclined toward the second member toward two opposite ends of the second member.

14. The fastener assembly of claim 9, further comprising a first stopper and a second stopper on the second member, wherein the first stopper and the second stopper are spaced apart from each other, and configured to restrict a movement of the second member after the fastening part is coupled to the assembling hole.

15. The fastener assembly of claim 14, wherein the first stopper protrudes from the second member and is connected to an upper end of the fastening part, and wherein a width of the first stopper corresponds to a width of the assembling hole.

16. The fastener assembly of claim 14, wherein the second stopper protrudes from the second member at a position spaced apart from the first stopper at an interval.

17. The fastener assembly of claim 14, further comprising:
a catching portion on the second stopper and extending from an upper end of the second stopper toward the first stopper; and
a planar portion on one of the fixing portions, wherein the planar portion is parallel to the second member and positioned below the catching portion.

18. A fastener assembly for a vehicle, the fastener assembly comprising:
a first member coupled to a vehicle trim and comprising a first coupling protrusion on a surface of the first member directed toward a panel;
a second member coupled to the panel and comprising a second coupling protrusion on a surface of the second member directed toward the vehicle trim, the second coupling protrusion being coupled to the first coupling protrusion, wherein the first member and the second member are coupled to each other by coupling of the first coupling protrusion to the second coupling protrusion; and
a sealing member fitted with a periphery of the first member or the second member and configured to seal a portion between the first member and the vehicle trim or a portion between the second member and the panel.

19. The fastener assembly of claim 18, wherein the sealing member comprises:
a through-hole with which the periphery of the first member or the periphery of the second member is fitted; and
a sealing portion extending from a portion where the through-hole is provided and configured to adjoin the vehicle trim or the panel.

20. The fastener assembly of claim 19, wherein the sealing member is fitted with the periphery of the second member and is configured to seal the portion between the second member and the panel.
